(19) United States
(12) Patent Application Publication
(10) Pub. No.: US 2026/0023239 A1
(43) Pub. Date: Jan. 22, 2026

(54) Electronic Devices with Sensors

(71) Applicant: Apple Inc., Cupertino, CA (US)

(72) Inventors: Guilhem S. Azzano, Sunnyvale, CA (US); Matin Seadat Beheshti, Sunnyvale, CA (US); Amin Farzaneh, San Jose, CA (US); Byung Hoon Min, Santa Clara, CA (US); Nicholas C. Soldner, Los Altos, CA (US)

(21) Appl. No.: 19/206,568

(22) Filed: May 13, 2025

Related U.S. Application Data
(60) Provisional application No. 63/672,191, filed on Jul. 16, 2024.

(51) Int. Cl. G02B 7/02; G01L 1/22; G02C 11/00; G06F 1/16

(52) U.S. Cl. CPC G02B 7/023; G01L 1/2262; G02C 11/10; G06F 1/163

(57) ABSTRACT

Electronic devices such as head-mounted electronic devices may include displays for presenting images to users. The head-mounted device may have actuators that move optical modules with respect to each other to accommodate different interpupillary distances. To hide internal structures from view, the rear of a head-mounted device may be provided with a fabric cover. Sensors may be used to measure nose contact arising from movement of the optical modules toward each other against the sides of a user's nose. The actuators may be halted or may otherwise be moved in response to sensor measurements to avoid undesired nose pressure. The sensors may be formed on opposing sides of the optical module, on a vision correcting lens, on a substrate that is coupled to the optical module, and/or in the fabric cover. The sensors may be configured to differentiate nose pressure from tension in the fabric cover.

This application claims the benefit of U.S. provisional patent application No. 63/672,191, filed Jul. 16, 2024, which is hereby incorporated by reference herein in its entirety.

### FIELD

This relates generally to electronic devices, and, more particularly, to wearable electronic devices such as head-mounted devices.

### BACKGROUND

Electronic devices such as head-mounted devices are configured to be worn on a head of a user. A head-mounted device may have left and right optical systems for presenting images to a user's left and right eyes. Not all users have the same physical distance separating their eyes. To accommodate differences in interpupillary distance between different users, a head-mounted device may have a mechanism for adjusting the positions of the left and right optical systems.

### SUMMARY

Electronic devices such as head-mounted electronic devices may include displays for presenting images to users. To accommodate variations in the interpupillary distances associated with different users, a head-mounted device may have actuators that move left-eye and right-eye optical modules with respect to each other. To hide internal structures from view, the rear of a head-mounted device may be provided with a cover.

Sensor circuitry such as capacitive sensor circuitry, switch-based sensor circuitry, force sensor circuitry, magnetic sensor circuitry, and/or other sensor circuitry may be used to measure nose pressure arising from movement of the optical modules toward each other against the sides of a user's nose. The actuators may halt movement of the optical modules toward each other based on sensor measurements, thereby avoiding undesired nose pressure as the optical modules are adjusted to accommodate a user's interpupillary distance.

The sensors may be formed on opposing sides of the optical module, on a vision correcting lens, on a substrate that is coupled to the optical module, and/or in the fabric cover. The sensors may be configured to differentiate nose pressure from tension in the fabric cover.

### BRIEF DESCRIPTION OF THE DRAWINGS

FIG. 1 is a top view of an illustrative head-mounted device in accordance with some embodiments.

FIG. 2 is a rear view of an illustrative head-mounted device in accordance with some embodiments.

FIG. 3 is a rear view of an illustrative head-mounted device having inner and outer sensors on optical modules in accordance with some embodiments.

FIG. 4 is a side view of an illustrative optical module attached to a removable vision correcting lens having a skirt that overlaps a sensor on the optical module and having one or more springs in accordance with some embodiments.

FIG. 5 is a side view of an illustrative optical module attached to a removable vision correcting lens having a skirt that overlaps a sensor on the optical module and having one or more magnets in accordance with some embodiments.

FIG. 6 is a side view of an illustrative optical module attached to a removable vision correcting lens having a sensor and contacts that are electrically coupled to the optical module in accordance with some embodiments.

FIG. 7 is a rear view of an illustrative removable prescription lens of the type shown in FIG. 6 having contacts that are electrically coupled to the optical module in accordance with some embodiments.

FIG. 8 is a side view of an illustrative optical module having a sensor formed from first and second electrodes in accordance with some embodiments.

FIG. 9 is a rear view an illustrative optical module of the type shown in FIG. 8 having a sensor formed from first and second electrodes that extend at least partially around the optical module in accordance with some embodiments.

FIG. 10 is a side view of an illustrative optical module having a sensor formed from first and second magnets separated by gap in accordance with some embodiments.

FIG. 11 is a rear view an illustrative optical module of the type shown in FIG. 10 having a sensor formed from first and second magnets that extend partially around the optical module in accordance with some embodiments.

FIG. 12 is a rear view an illustrative optical module of the type shown in FIG. 10 having a sensor formed from first and second magnets that extend entirely around the optical module in accordance with some embodiments.

FIG. 13 is a rear view of an illustrative optical module having a sensor on a flexible membrane that is coupled to the optical module in accordance with some embodiments.

FIG. 14 is a rear view of an illustrative optical module having a sensor on a rigid member that is coupled to the optical module at a hinge in accordance with some embodiments.

FIG. 15 is a rear view of an illustrative optical module having sensors on one or more cantilevers that are distributed around the optical module in accordance with some embodiments.

FIG. 16 is a rear view of an illustrative optical module having first and second sensors to reduce false positive measurements in accordance with some embodiments.

### DETAILED DESCRIPTION

An electronic device such as a head-mounted device may have a front face that faces away from a user's head and may have an opposing rear face that faces the user's head. Optical modules on the rear face may be used to provide images to a user's eyes. The positions of the optical modules may be adjusted to accommodate different user interpupillary distances. Internal device structures may be hidden from view by the user by covering the rear face of the device with a curtain. The curtain, which may sometimes be referred to as a cover, covering structure, rear housing cover, fabric, rear housing wall, rear housing structure, cosmetic covering, etc., may help block potentially unsightly internal structures from view while accommodating movement of the optical modules. To ensure that the optical modules do not press too firmly against a user's nose as the optical module positions are adjusted, nose sensor circuitry may be incorporated into the head-mounted device. When a situation is detected in which more than a desired amount of pressure might be applied to a user's nose, the optical modules may be positioned to alleviate this pressure.

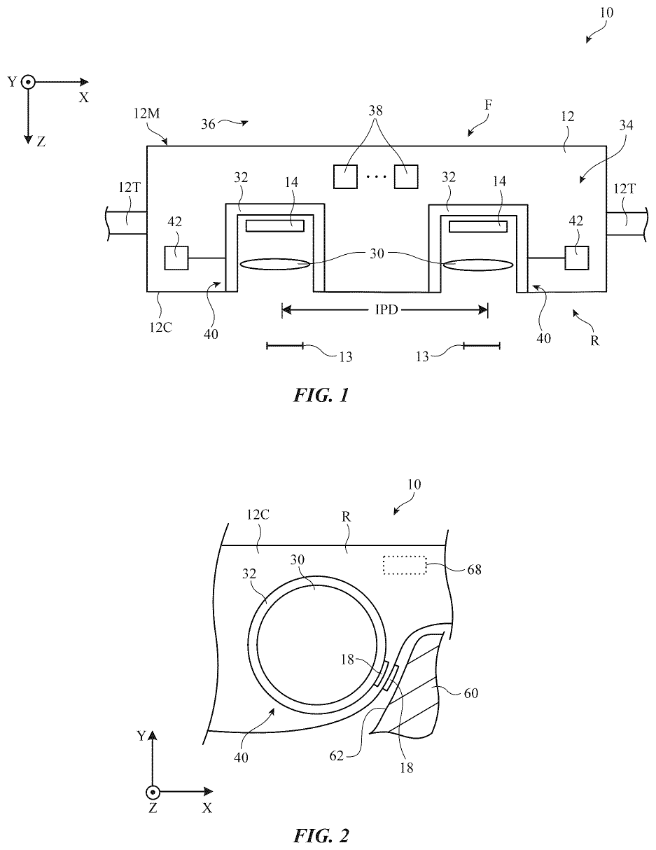

A top view of an illustrative head-mounted device with a curtain is shown in FIG. 1. As shown in FIG. 1, head-mounted devices such as electronic device 10 may have head-mounted support structures such as housing 12. Housing 12 may include portions (e.g., support structures 12T) to allow device 10 to be worn on a user's head. Support structures 12T may be formed from fabric, polymer, metal, and/or other material. Support structures 12T may form a strap or other head-mounted support structures that help support device 10 on a user's head. A main support structure (e.g., main housing portion 12M) of housing 12 may support electronic components such as displays 14. Main housing portion 12M may include housing structures formed from metal, polymer, glass, ceramic, and/or other material. For example, housing portion 12M may have housing walls on front face F and housing walls on adjacent top, bottom, left, and right side faces that are formed from rigid polymer or other rigid support structures and these rigid walls may optionally be covered with electrical components, fabric, leather, or other soft materials, etc. The walls of housing portion 12M may enclose internal components 38 in interior region 34 of device 10 and may separate interior region 34 from the environment surrounding device 10 (exterior region 36). Internal components 38 may include integrated circuits, actuators, batteries, sensors, and/or other circuits and structures for device 10. Housing 12 may be configured to be worn on a head of a user and may form glasses, a hat, a helmet, goggles, and/or other head-mounted device. Configurations in which housing 12 forms goggles may sometimes be described herein as an example.

Front face F of housing 12 may face outwardly away from a user's head and face. Opposing rear face R of housing 12 may face the user. Portions of housing 12 (e.g., portions of main housing 12M) on rear face R may form a cover such as curtain 12C. In an illustrative configuration, curtain 12C includes a fabric layer that that is attached to the rigid support structures of housing 12 and that separates interior region 34 from the exterior region to the rear of device 10. Other structures may be used in forming curtain 12C, if desired. The presence of curtain 12C on rear face R may help hide internal housing structures, internal components 38, and other structures in interior region 34 from view by a user.

Device 10 may have left and right optical modules 40. Each optical module, which may sometimes be referred to as an optical assembly or display and lens support, may include a respective display 14, lens 30, and supporting structures such as support structure (support) 32. Support structure 32, which may sometimes be referred to as lens barrels or optical module support structure, may include hollow cylindrical structures with open ends or other supporting structures to house displays 14 and lenses 30. Support structures 32 of device 10 may, for example, include a left lens barrel that supports a left display 14 and left lens 30 and a right lens barrel that supports a right display 14 and right lens 30. Displays 14 may include arrays of pixels to produce images. Displays 14 may, for example, include organic light-emitting diode pixels formed on substrates with thin-film circuitry and/or formed on semiconductor substrates, pixels formed from crystalline semiconductor dies, liquid crystal display pixels, scanning display devices, and/or other display devices for producing images. Lenses 30 may include one or more lens elements for providing image light from displays 14 to respective eyes boxes 13. Lenses may be implemented using refractive glass lens elements, using mirror lens structures (catadioptric lenses), using holographic lenses, and/or other lens systems. When a user's eyes are located in eye boxes 13, displays (display panels) 14 operate together to form a display for device 10 (e.g., the images provided by respective left and right optical modules 40 may be viewed by the user's eyes in eye boxes 13 so that a stereoscopic image is created for the user). The left image from the left optical module fuses with the right image from a right optical module while the display is viewed by the user.

Not all users have the same interpupillary distance IPD. To provide device 10 with the ability to adjust the interpupillary spacing between modules 40 along lateral dimension X and thereby adjust the spacing IPD between eye boxes 13 to accommodate different user interpupillary distances, device 10 may be provided with actuators 42. Actuators 42 can be manually controlled and/or electrically controlled (e.g., actuators 42 may be computer-controlled motors) for moving support structures 32 relative to each other.

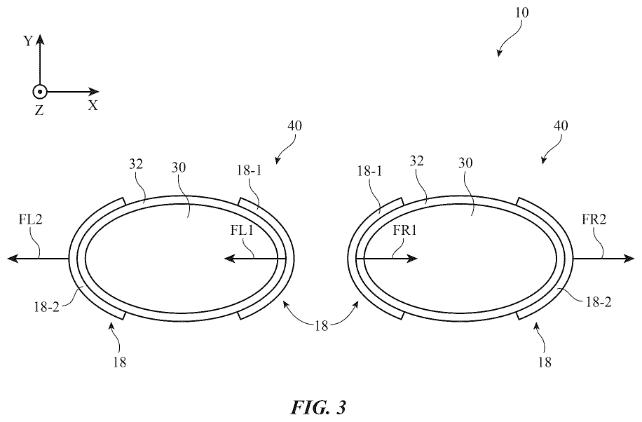

As shown in FIG. 2, curtain 12C may cover rear face R while leaving lenses 30 of optical modules 40 uncovered (e.g., curtain 12C may have openings that are aligned with and receive modules 40). As modules 40 are moved relative to each other along dimension X to accommodate different interpupillary distances for different users, modules 40 move relative to fixed housing structures such as the walls of main portion 12M and move relative to each other. To prevent undesired wrinkling and buckling of curtain 12C as optical modules 40 are moved relative to rigid portions of housing 12M and relative to each other, a fabric layer or other cover layer in curtain 12C may be configured to slide, stretch, open/close, and/or otherwise adjust to accommodate optical module movement.

Device 10 may make sensor measurements to ascertain a user's IPD. As an example, modules 40 may have rear-facing cameras that can capture images of a user's eyes and thereby determine the spacing between the user's eyes. Using the measured value of IPD for a given user from the cameras or other IPD sensors in device 10, actuators 42 may adjust the spacing between modules 40, so that the modules 40 are spaced apart by the same amount as the user's eyes. Matching the optical module spacing to the user's measured IPD value in this way may help enhance the user's visual comfort while observing content on displays 14.

Although visual comfort may be enhanced by matching optical module spacing to the measured IPD of the user, the shapes of some users' noses is such that optical modules 40 will start to exert undesired amounts of pressure on the nose as modules 40 are brought closer to each other. This undesired excess pressure on the sides of a user's nose may occur before modules 40 are spaced sufficiently close to match a target IPD. To prevent nose discomfort in such situations, device 10 may include one or more sensors such as nose sensors 18. Nose sensors 18 (sometimes referred to as sensors, nose sensing circuitry, sensor circuitry, etc.) may include capacitive nose sensors, switched-based nose sensors, strain gauges, distance sensors (e.g., proximity sensors, self-mixing interferometers, ultrasonic range finders, time-of-flight sensors, etc.), cameras, and/or other sensor circuitry that may be used by device 10 to detect when the optical modules 40 are contacting nose surface 62 and/or how much force is being applied by optical modules 40 on nose surface 62. When it is determined that optical modules 40 are at risk of pressing too firmly against a user's nose, suitable action can be taken. For example, if sensor 18 detects contact between a sensor electrode and surface 62 of the user's nose, actuators 42 can halt the inward movement of modules 40 and/or actuators 42 may move modules 40 slightly away from each other.

As shown in the rear view of the portion of device 10 of FIG. 2, curtain 12C may have an opening to accommodate optical module 40, including lens 30 and lens barrel 32. Curtain 12C and/or other portions of device 10 (e.g., polymer nose bridge portions and/or other rear covering structures, sometimes collectively referred to herein as curtain 12C) may be configured to form a comfortable nose bridge structure that rests on the bridge of nose 60 while device 10 is being worn on a user's head. For some users, portions of side nose surface 62 will be separated by a gap from curtain 12C or will lightly contact curtain 12C. For other users, there is a risk that optical module 40 and/or associated portions of curtain 12C that are located between module 40 and side nose surface 62 will press uncomfortably against side nose surface 62 (e.g., in the +X direction in the example of FIG. 2). This pressure against nose surface 62 may be created when module 40 is being moved inwardly toward the nose (e.g., in the +X direction in the FIG. 2 example). Modules 40 may, for example, be moved inwardly by actuators 42 when it is desired to reduce the module-to-module spacing in device 10 to accommodate a user's measured IPD. By placing sensor circuitry 18 on optical module 40 (e.g., on lens barrel 32) and/or on curtain 12C, conditions leading to uncomfortable nose pressure from optical modules 40 can be avoided.

Sensors 18 that detect nose pressure conditions may be, as examples, capacitive sensors (e.g., capacitive sensors that make capacitance measurements using self-capacitance and/or mutual capacitance measurement techniques), switch-based sensors (e.g., sensors that detect when two electrodes have come into contact with each other to close a circuit by monitoring the resistance between the electrodes), force sensors (e.g., strain gauges, capacitive force sensors, etc.), magnetic sensors, and/or other suitable sensors. The sensors may have electrodes and associated measurement circuitry. One or more electrodes for making capacitance measurements and/or switch sensor measurements may be located on optical modules 40 (e.g., on lens barrels 32) and/or on curtain 12C. These electrodes may be coupled to measurement circuitry 68 (e.g., capacitance measurement circuitry, resistance measurement circuitry, and/or other measurement circuitry). During operation, circuitry 68 can use the electrodes to detect changes in capacitance and/or resistance that are indicative of conditions associated with uncomfortable nose pressure, so that corrective action can be taken. In addition to or instead of electrodes, sensors 18 may include strain gauges, magnets, magnetic sensors, distance sensors, and/or other circuitry. Measurement circuitry 68 may be configured to monitor the strain gauges, magnetic sensors, distance sensors, and/or other sensing circuitry to detect conditions associated with uncomfortable nose pressure, so that corrective action can be taken.

In some arrangements, nose sensor 18 is formed on optical module 40 (e.g., on lens barrel 32) and curtain 12C includes fabric that rests on top of nose sensor 18. Because the fabric of curtain 12C stretches and contracts to accommodate movement of optical modules 40, the amount of force applied by curtain 12C on nose sensor 18 may change as the distance between optical modules 40 changes. If care is not taken, this dynamic load on nose sensor 18 can lead to inaccurate conclusions about the forces that are applied to nose sensor 18 by nose surface 62. In order to differentiate curtain tension (e.g., forces applied to nose sensor 18 by curtain 12C) from nose contact, one or more additional sensors may be formed on the outer sides of optical modules 40, as shown in FIG. 3.

FIG. 3 is a rear view of device 10 showing how nose sensor circuitry 18 may include inner sensors 18-1 on inner (e.g., nose-facing) sides of optical modules 40 (e.g., on the inner sides of lens barrels 32) and may include outer sensors 18-2 on opposing outer (e.g., world-facing) sides of optical modules 40. Inner sensors 18-1 and outer sensors 18-2 may be force sensors that include multiple sensing elements distributed around the sensing area, if desired. For example, inner sensors 18-1 and outer sensors 18-2 may be configured as a Wheatstone bridge. Placing nose sensors 18 on first and second opposing sides of lens barrel 32 may allow measurement circuitry 68 to compensate for the dynamic load that may be applied by curtain 12C on sensors 18.

Inner sensor 18-1 of left optical module 40 may be configured to measure force FL1 on inner sensor 18-1. Force FL1 may include forces applied by nose surface 62 as well as forces applied by curtain 12C on inner sensor 18-1. Outer sensor 18-2 on left optical module 40 may be configured to measure force FL2 on outer sensor 18-2. Force FL2 may include forces applied by curtain 12C on outer sensor 18-2. Nose surface 62 does not apply any forces to outer sensor 18-2. As such, measurement circuitry 68 can compensate for curtain tension by subtracting force FL2 from force FL1, with the result being indicative of the amount of force applied by nose surface 62 on inner sensor 18-1 of left optical module 40.

Similarly, inner sensor 18-1 of right optical module 40 may be configured to measure force FRI on inner sensor 18-1. Force FR1 may include forces applied by nose surface 62 as well as forces applied by curtain 12C on inner sensor 18-1. Outer sensor 18-2 on right optical module 40 may be configured to measure force FR2 on outer sensor 18-2. Force FR2 may include forces applied by curtain 12C on outer sensor 18-2. Nose surface 62 does not apply any forces to outer sensor 18-2. By subtracting force FR2 from force FR1, measurement circuitry 68 can compensate for curtain tension and can determine the amount of force applied by nose surface 62 on inner sensor 18-1 of right optical module 40.

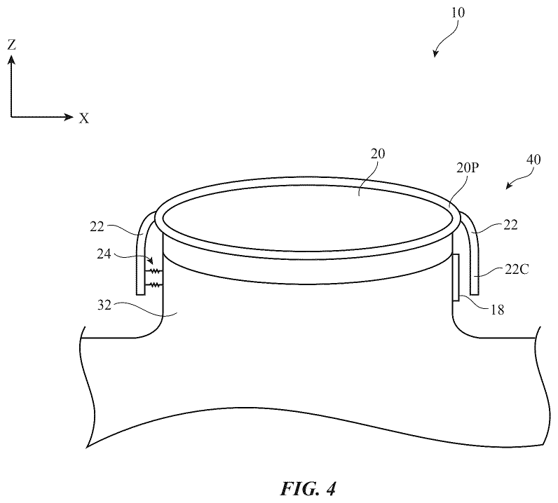

Not all users have the same eyeglasses prescription. Accordingly, it may be desirable to provide removable individualized vision correcting lenses for each user. A user may obtain an appropriate vision correction lens (e.g., a lens that corrects the normal lens 30 in an optical module for nearsightedness or farsightedness and/or astigmatism) and, prior to use of device 10, may install this individualized corrective lens in device 10. A user may, for example, install a left vision correcting lens in a left optical module and may install a right vision correcting lens in a right optical module. In the diagram of FIG. 4, an illustrative vision correcting lens such as vision correcting lens 20 (sometimes referred to as prescription lens 20) is shown as being removably attached to lens barrel 32. Vision correcting lens 20 may be mounted in alignment with lens 30 and display 14 of FIG. 1, for example. Vision correcting lens 20 may be removably coupled to optical module 40 (e.g., lens barrel 32) using clips, magnets, mating engagement structures, and/or other attachment mechanisms.

In some arrangements, vision correcting lens 20 may have an outer perimeter 20P that protrudes laterally outward relative to lens barrel 32. To ensure that outer perimeter 20P does not apply excessive pressure to nose surface 62 without being detected by nose sensor 18, vision correcting lens 20 may be provided with a skirt such as skirt 22 that extends partially or completely around the perimeter of lens barrel 32 and that overlaps nose sensor 18 on lens barrel 32. Skirt 22 (sometimes referred to as a jacket, protruding structure, lip, etc.) may extend from outer perimeter 20P and may include portion 22C that overlaps nose sensor 18. Portion 22C of skirt 22 and nose sensor 18 may be separated by a gap. When the distance between optical modules 40 is adjusted and optical modules 40 approach nose surface 62, nose surface 62 may apply pressure against portion 22C of skirt 22 that causes skirt 22 to shift (e.g., bend) toward nose sensor 18. In some arrangements, nose sensor 18 may be a force sensor (e.g., a strain gauge, capacitive sensor, etc.) configured to measure the force applied by skirt 22 on sensor 18. In other arrangements, nose sensor 18 may include a first electrode and portion 22C of skirt 22 may include a second electrode. With this type of arrangement, measurement circuitry 68 may measure the distance between the first and second electrodes and/or may detect when the two electrodes come into contact by monitoring the resistance and/or capacitance between the two electrodes.

To ensure that skirt portion 22C returns to its original position (e.g., to a predetermined position relative to nose sensor 18) when the forces on skirt 22 are no longer present, device 10 may include a debounce mechanism such as one or more springs 24 interposed between skirt 22 and lens barrel 32. Springs 24 may be located on the outer side of optical module 40 (e.g., opposite sensor 18 on the inner side of optical module 40). Springs 24 may pull skirt 22 inwardly toward lens barrel 32 (e.g., toward a nose bridge portion of housing 12).

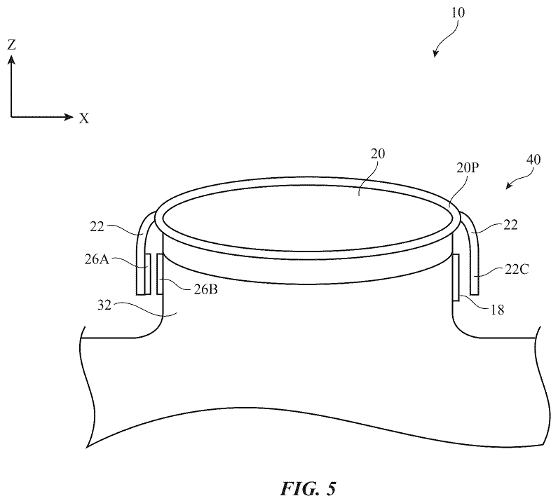

In addition to or instead of using springs to form a debouncing mechanism for skirt 22, one or more magnets may be used to ensure that skirt portion 22C returns to a predetermined position relative to nose sensor 18. As shown in FIG. 5, for example, one or more magnets such as magnet 26A may be formed on skirt 22, and one or more magnets such as magnet 26B may be formed on lens barrel 32. Magnets 26A and 26B may be located on the outer side of optical module 40 (e.g., opposite sensor 18 on the inner side of optical module 40). Magnets 26A and 26B may have magnetic poles that are arranged such that magnet 26B attracts magnet 26A and pulls skirt 22 inwardly toward lens barrel 32 (e.g., toward a nose bridge portion of housing 12).

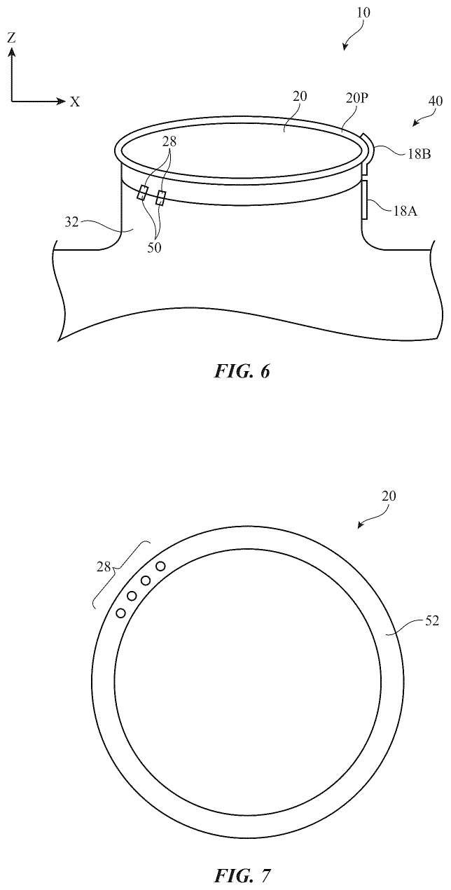

If desired, nose sensing circuitry 18 may be incorporated into vision correcting lens 20. This type of arrangement is illustrated in FIG. 6. As shown in FIG. 6, nose sensing circuitry 18 may include one or more sensors 18A on lens barrel 32 and one or more sensors 18B on vision correcting lens 20. Sensors 18A and 18B may be the same type of sensor or may be different types of sensors. Sensor 18B may, for example, be a capacitive force sensor, a resistive force sensor, a switch-based sensor, a strain gauge, and/or any other suitable sensor. The presence of nose sensor 18B on the nose-facing side of vision correcting lens 20 (e.g., on protruding perimeter 20P) may ensure that pressure on nose surface 62 can be detected even when perimeter 20P contacts nose surface 62 before sensor 18A on lens barrel 32 contacts nose surface 62.

Sensor measurements from sensor 18B may be conveyed to measurement circuitry 68 through a wireless link, an optical link, and/or a conductive path. As shown in FIG. 6, for example, vision correcting lens 20 may include contacts 28 and optical module 40 (e.g., lens barrel 32) may include contacts 50 that mate with contacts 28. FIG. 7 shows a top view of vision correcting lens 20 including contacts 28. Contacts 28 may be retractable pins that retract inwardly into a frame on lens 20 such as vision correcting lens frame 52. When vision correcting lens 20 is attached to lens barrel 32, contacts 50 may electrically couple to contacts 28 and contacts 28 may retract into frame 52. This is merely illustrative. If desired, contacts 28 may be non-retractable contacts or any other suitable electrical contacts.

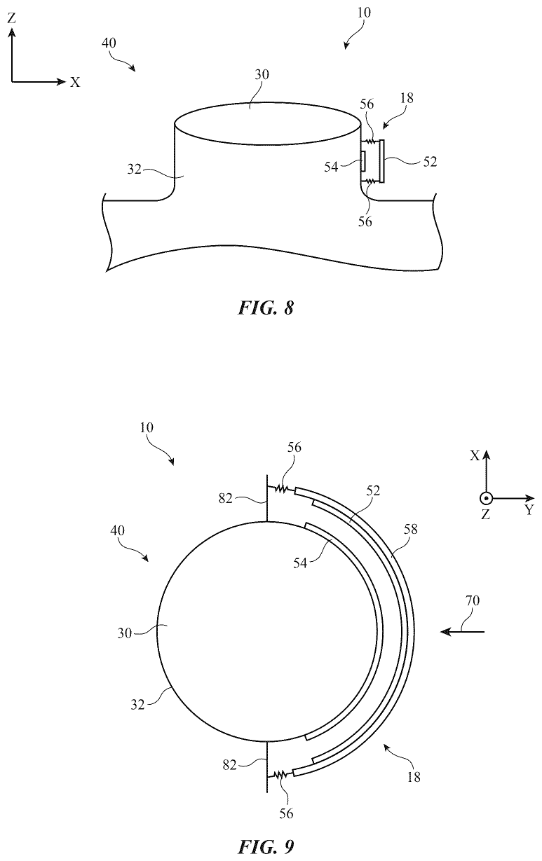

FIG. 8 is a side view of optical module 40 showing an illustrative configuration for nose sensor 18. In the example of FIG. 8, nose sensor 18 includes a first electrode such as electrode 54 on a nose-facing surface of lens barrel 32 and a second electrode such as electrode 52 that is separated from first electrode 54 by a gap. Electrode 54 may be formed directly on the surface of lens barrel 32, whereas electrode 52 may be formed on a substrate that is coupled to lens barrel 32 using an elastic member such as elastic members 56 (e.g., springs or other elastic members that allow the substrate on which electrode 52 is formed to move relative to lens barrel 32).

Electrodes 52 and 54 may form a switch-based sensor. As nose surface 62 presses against electrode 52, electrode 52 may come into contact with electrode 54 and may alter the resistance between electrodes 52 and electrode 54. Measurement circuitry 68 may monitor the resistance between electrodes 52 and electrode 54 to determine when a closed circuit is formed by electrode 52 coming into contact with electrode 54. In some arrangements, electrodes 52 and 54 may form a capacitive sensor and measurement circuitry 68 may measure the distance between electrodes 52 and 54 by monitoring for capacitance changes between electrodes 52 and 54.

FIG. 9 is a rear view of optical module 40 of FIG. 8. As shown in FIG. 9, electrode 54 may wrap partially around lens barrel 32. Electrode 52 may be formed on a substrate such as substrate 58. Substrate 58 may be a curved substrate that curves at least partially around lens barrel 32 (e.g., around the inner side of optical module 40). Substrate 58 may be movable relative to optical module 40 (e.g., relative to lens barrel 32). In particular, substrate 58 may have first and second opposing ends respectively coupled to first and second support structures 82 on lens barrel 32 via elastic members 56. As forces are applied in direction 70 to substrate 58 (e.g., by nose surface 62), substrate 58 may be pushed in direction 70 toward lens barrel 32, bringing electrode 52 closer to electrode 54. Measurement circuitry 68 may monitor sensor 18 for contact between electrodes 52 and 54 and/or may monitor sensor 18 for changes in distance between electrodes 52 and 54 to determine if and when nose pressure becomes excessive and corrective action should be taken.

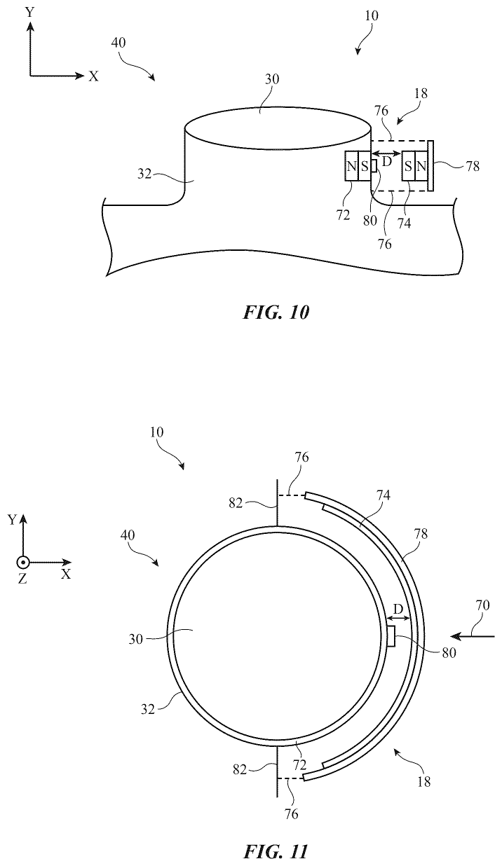

In the example of FIG. 10, nose sensing circuitry 18 includes a first magnet such as magnet 72 on a nose-facing surface of lens barrel 32 and a second magnet such as magnet 74 that is separated from first electrode 72 by a gap. Magnet 72 may be formed directly on the surface of lens barrel 32 (or may form part of lens barrel 32), whereas magnet 74 may be formed on a substrate such as substrate 78 (or may form part of substrate 78) that is coupled to lens barrel 32 using a flexible member such as flexible members 76 (e.g., springs, fabric, elastomer, etc.). Substrate 78 may, if desired, be a curved substrate that wraps at least partially around lens barrel 32 and that is movable relative to lens barrel 32.

Magnets 72 and 74 may have magnetic poles that are arranged such that magnets 72 and 74 repel each other. For example, magnet 72 may have a north pole N facing lens barrel 32 and a south pole S facing magnet 74. Magnet 74 may have a south pole S facing magnet 72 and a north pole N facing substrate 78. The repelling force between magnets 72 and 74 serves to maintain a distance D between magnets 72 and 74 when no force is applied to substrate 78. When a force greater than this repelling force is applied (e.g., by nose surface 62) to substrate 78, magnet 74 may move toward magnet 72 and distance D may decrease. A sensor such as magnetic sensor 80 (e.g., a Hall sensor or other magnetic sensor) may be formed on lens barrel 32 (e.g., between magnets 72 and 74) and may be used to measure changes in the magnetic field produced by magnets 72 and 74. Measurement circuitry 68 may be configured to determine when contact has occurred between magnets 72 and 74 and/or to determine the distance D between magnets 72 and 74 based on data from magnetic sensor 80.

FIG. 11 is a rear view of optical module 40 of FIG. 10. As shown in FIG. 11, magnet 72 may wrap around lens barrel 32 (e.g., around the entire circumference of lens barrel 32, if desired). Magnet 74 may be formed on a substrate such as substrate 78. Substrate 78 may curve partially around lens barrel 32 (e.g., half-way around lens barrel 32, if desired). Substrate 78 may have first and second opposing ends respectively coupled to first and second support structures 82 on lens barrel 32 via flexible members 76. As forces are applied in direction 70 to substrate 78 (e.g., by nose surface 62), substrate 78 may be pushed in direction 70 toward lens barrel 32, bringing magnet 74 closer to magnet 72. Measurement circuitry 68 may monitor magnetic sensor 80 for contact between magnets 72 and 74 and/or may monitor magnetic sensor 80 for changes in distance D between magnets 72 and 74 to determine if and when nose pressure becomes excessive and corrective action should be taken.

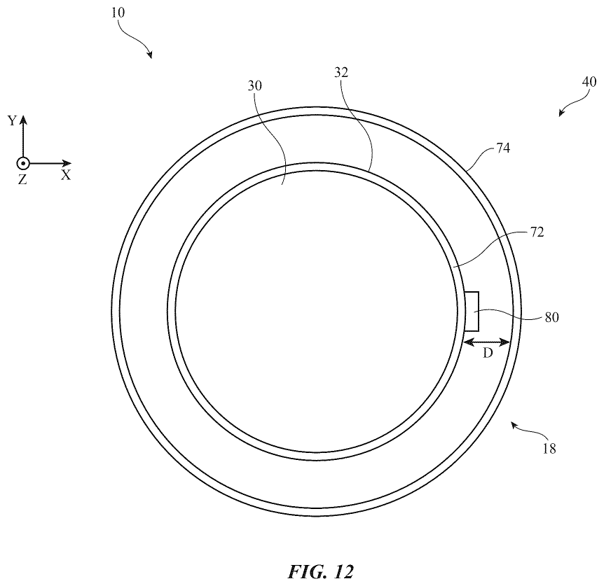

The example of FIG. 11 in which substrate 78 and magnet 74 wrap only partially around lens barrel 32 is merely illustrative. If desired, magnet 74 and magnet 72 may form concentric circles, as shown in FIG. 12. In the example of FIG. 12, substrate 78 and magnet 74 wrap around the entire circumference of lens barrel 32. As a force is applied to substrate 78 (e.g., by nose surface 62), substrate 78 and magnet 74 may be pushed toward magnet 72. Measurement circuitry 68 may monitor magnetic sensor 80 for contact between magnets 72 and 74 and/or may monitor magnetic sensor 80 for changes in distance D between magnets 72 and 74 to determine if and when nose pressure becomes excessive and corrective action should be taken. Due to the repelling force between magnets 72 and 74, magnet 74 may return to its original position (e.g., a predetermined distance D away from magnet 72) when no force is applied to substrate 78.

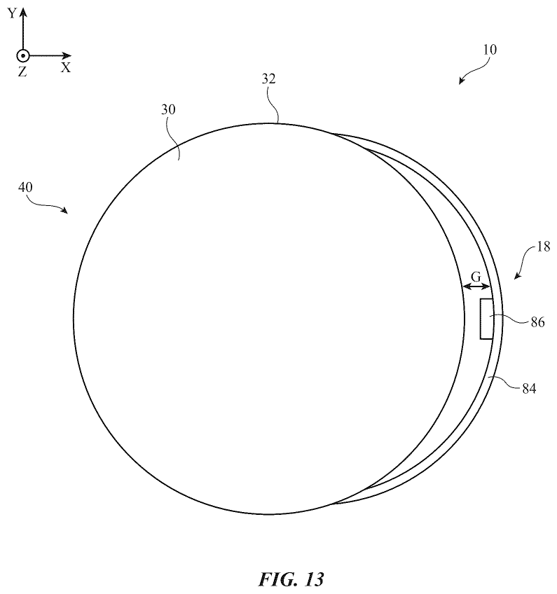

In the example of FIG. 13, nose sensor 18 includes a flexible membrane such as flexible membrane 84 coupled to lens barrel 32. Flexible membrane 84 (sometimes referred to as substrate 84) may be formed from elastomer, fabric, polymer, and/or other suitable flexible materials that allow membrane 84 to move relative to optical module 40 (e.g., relative to lens barrel 32). Flexible membrane 84 may have first and second opposing ends coupled to lens barrel 32. In the nose sensing area of optical module 40, a gap G may be present between flexible membrane 84 and lens barrel 32. This allows flexible membrane 84 to flex inwardly toward lens barrel 32 when pressure is applied to flexible membrane 84. A strain gauge such as strain gauge 86 may be formed on flexible membrane 84 (e.g., on an inner or outer surface of membrane 84) and may be configured to measure an amount of force applied to flexible membrane 84 (e.g., by nose surface 62) as flexible membrane 84 moves relative to lens barrel 32. Measurement circuitry 68 may monitor strain gauge 86 to determine if and when nose pressure becomes excessive and corrective action should be taken.

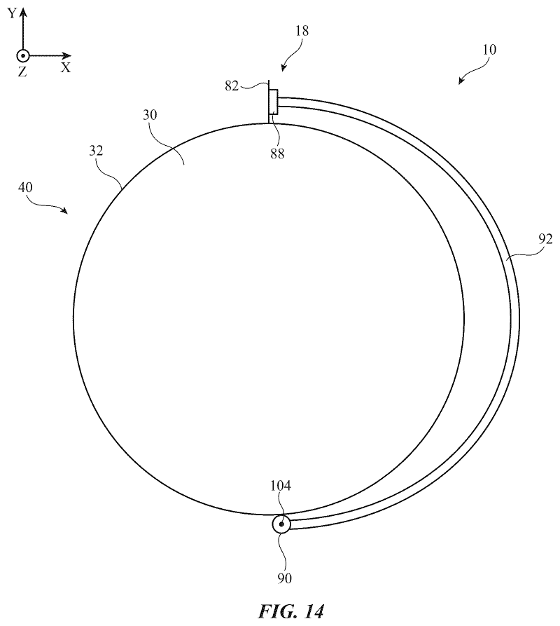

In the example of FIG. 14, nose sensor 18 includes a rigid member such as rigid member 92 that curves at least partially around optical module 40. Rigid member 92 (sometimes referred to as substrate 92) may be formed from metal, polymer, and/or any other suitable material. Rigid member 92 may have a first end coupled to lens barrel 32 using a hinge such as hinge 90 and a second opposing end that is free to move relative to lens barrel 32. A sensor such as sensor 88 may be mounted to support structure 82 on lens barrel 32. Rigid member 92 may be configured to rotate relative to lens barrel 32 about hinge axis 104 of hinge 90. When pressure is applied to rigid member 92, rigid member 92 may be pushed toward lens barrel 32 as rigid member 92 rotates about hinge axis 104. Sensor 88 may be a force sensor (e.g., a strain gauge, capacitive sensor, etc.) configured to measure the force applied by rigid member 92 on sensor 88. In other arrangements, sensor 88 of nose sensor 18 may include a first electrode on support structure 82 and a second electrode on the end of rigid member 92. Measurement circuitry 68 may detect contact and/or distance between the two electrodes by detecting changes in capacitance or resistance between the two electrodes.

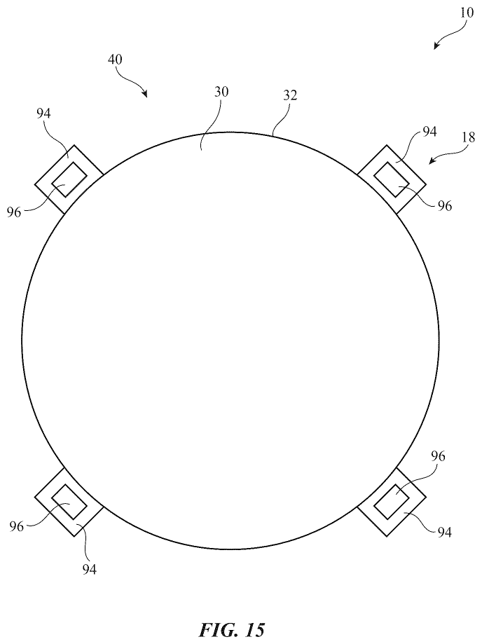

In the example of FIG. 15, nose sensor 18 includes one or more cantilevers such as cantilevers 94 that extend radially outward from lens barrel 32. A strain gauge such as strain gauge 96 may be formed on each cantilever 94. In the example of FIG. 15, four cantilevers 94 with respective strain gauges 96 are distributed around the periphery of lens barrel 32. This is merely illustrative. If desired, there may be one, two, three, four, five, or more than five cantilevers 94 with respective strain gauges 96 distributed around the periphery of lens barrel 32. Contact made with optical module 40 may result in a strain being applied to strain gauges 96. Measurement circuitry 68 may monitor strain gauges 96 to determine if and when nose pressure becomes excessive and corrective action should be taken.

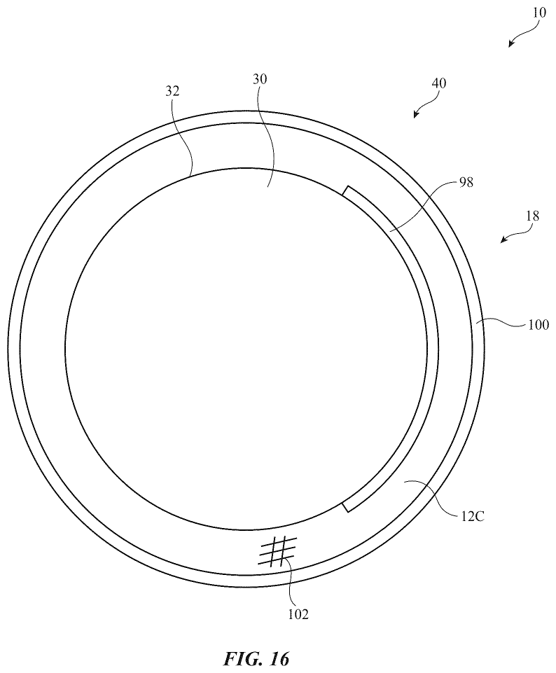

In the example of FIG. 16, nose sensor 18 includes first and second sensors to help reduce false positive measurements (e.g., measurements that erroneously indicate nose contact). Nose sensor 18 may include a first sensor such as capacitive sensor 100 in curtain 12C and a second sensor such as force sensing resistive sensor 98 on lens barrel 32. Capacitive sensor 100 may be formed from conductive strands in fabric 102 that forms curtain 12C, or capacitive sensor 100 may be attached to fabric 102 of curtain 12C using adhesive, stitching, and/or other attachment mechanisms.

Capacitive sensor 100 may have greater sensing resolution than resistive sensor 98, but capacitive sensor 100 may be more sensitive to environmental factors such as humidity, sweat, and other environmental factors. To ensure that these environmental factors do not falsely trigger a nose contact scenario, measurement circuitry 68 may compare sensor data from capacitive sensor 100 with sensor data from resistive sensor 98 using a comparator circuit. If capacitive sensor 100 detects a non-zero amount of force on curtain 12C but the force is not sufficiently great enough to be detected by resistive sensor 98, measurement circuitry 68 may conclude that nose contact has not yet occurred or that the nose contact is not yet excessive. On the other hand, if capacitive sensor 100 detects a non-zero amount of force on curtain 12C and the force is sufficiently great enough to be detected by resistive sensor 98, measurement circuitry 68 may conclude that nose contact has occurred and may determine if corrective action should be taken (e.g., movement of modules 40 may be halted or otherwise controlled based on information from capacitive sensor 100 and force sensor 98).

In some embodiments, sensors may gather personal user information. To ensure that the privacy of users is preserved, all applicable privacy regulations should be met or exceeded and best practices for handling of personal user information should be followed. Users may be permitted to control the use of their personal information in accordance with their preferences.

The foregoing is merely illustrative and various modifications can be made to the described embodiments. The foregoing embodiments may be implemented individually or in any combination.

What is claimed is:

1. A head-mounted device, comprising:
a head-mounted housing having an interior region;
an optical assembly in the interior region of the head-mounted housing that is configured to provide images to an eye box, wherein the optical assembly has first and second opposing sides;
a cover that is configured to block the interior region from view, wherein the cover has an opening aligned with the optical assembly; and
a first force sensor on the first side of the optical assembly and a second force sensor on the second side of the optical assembly.

2. The head-mounted device defined in claim 1 wherein the first and second force sensors respectively comprise first and second strain gauges.

3. The head-mounted device defined in claim 2 wherein the optical assembly comprises a lens barrel and wherein the first and second strain gauges are formed on opposing sides of the lens barrel.

4. The head-mounted device defined in claim 1 further comprising an actuator configured to move the optical assembly to accommodate an interpupillary distance, wherein the actuator is configured to halt movement of the optical assembly based at least partly on the information from the first and second force sensors.

5. The head-mounted device defined in claim 1 wherein the cover comprises fabric that applies a force to the first and second force sensors.

6. The head-mounted device defined in claim 5 wherein the first force sensor produces first sensor data, the second force sensor produces second sensor data, and the second sensor data is used to compensate for the force applied to the first sensor by the fabric.

7. The head-mounted device defined in claim 1 wherein the first and second force sensors are configured as a Wheatstone bridge.

8. A head-mounted device, comprising:
a head-mounted support structure;
an optical assembly supported by the head-mounted support structure;
a sensor on the optical assembly; and
a removable vision correcting lens coupled to the optical assembly, wherein the vision correcting lens comprises a skirt that wraps around the optical assembly and that overlaps the sensor.

9. The head-mounted device defined in claim 8 wherein the sensor comprises a first electrode, the skirt comprises a second electrode, and wherein the first and second electrodes form a switch.

10. The head-mounted device defined in claim 8 wherein the sensor comprises a force sensor that measures a force applied by the skirt on the force sensor.

11. The head-mounted device defined in claim 8 further comprising an actuator configured to move the optical assembly to accommodate an interpupillary distance, wherein the actuator is configured to halt movement of the optical assembly based at least partly on the information from the sensor.

12. A vision correcting lens configured to be removably coupled to an optical assembly of a head-mounted device, the vision correcting lens comprising:
a frame;
a prescription lens supported by the frame; and
a sensor on the frame that is configured to detect at least one of contact and pressure applied to the sensor.

13. The vision correcting lens defined in claim 12 further comprising electrical contacts on the frame that are configured to electrically couple to corresponding electrical contacts on the optical assembly.

14. The vision correcting lens defined in claim 13 wherein the electrical contacts are configured to retract into the frame when the vision correcting lens is coupled to the optical assembly.

15. A head-mounted device, comprising:
a head-mounted housing;
an optical assembly supported by the head-mounted housing that is configured to provide images to an eye box;
a substrate coupled the optical assembly and that is movable relative to the optical assembly;
a sensor configured to detect movement of the substrate relative to the optical assembly, wherein movement of the optical assembly is controlled at least partly based on information from the sensor.

16. The head-mounted device defined in claim 15 wherein the substrate comprises a curved substrate that wraps at least partially around the optical assembly and wherein the sensor comprises a first electrode on the optical assembly and a second electrode on the curved substrate.

17. The head-mounted device defined in claim 15 wherein the substrate comprises a curved substrate that wraps at least partially around the optical assembly, wherein the head-mounted device further comprises a first magnet on the optical assembly and a second magnet on the curved substrate, and wherein the sensor comprises a magnetic sensor.

18. The head-mounted device defined in claim 15 wherein the substrate comprises a curved flexible membrane that wraps at least partially around the optical assembly and wherein the sensor comprises a strain gauge on the curved flexible membrane.

19. The head-mounted device defined in claim 15 wherein the substrate comprises a curved substrate that wraps at least partially around the optical assembly, the head-mounted device further comprising a hinge that couples the curved substrate to the optical assembly.

20. The head-mounted device defined in claim 15 wherein the substrate comprises a cantilever that extends radially outward from the optical assembly and wherein the sensor comprises a strain gauge on the cantilever.

21. A head-mounted device, comprising:
a head-mounted housing having an interior region;
an optical assembly in the interior region of the head-mounted housing that is configured to provide images to an eye box;
a cover that is configured to block the interior region from view, wherein the cover has an opening aligned with the optical assembly;
a capacitive force sensor on the cover; and
a resistive force sensor on the optical assembly, wherein movement of the optical assembly is controlled at least partly based on information from the capacitive force sensor and the resistive force sensor.

22. The head-mounted device defined in claim 21 wherein the cover comprises fabric and the capacitive force sensor is formed from conductive strands in the fabric.
